(19) United States
(12) Patent Application Publication
(10) Pub. No.: US 2024/0016128 A1
(43) Pub. Date: Jan. 18, 2024

(54) BEEHIVE WITH HIGH INSULATED COVER

(71) Applicant: Northwinds BeeCo, LLC, Minneapolis, MN (US)

(72) Inventor: Peggy DeSanto, Minneapolis, MN (US)

(21) Appl. No.: 18/165,608

(22) Filed: Feb. 7, 2023

Related U.S. Application Data
(60) Provisional application No. 63/390,034, filed on Jul. 18, 2022.

(51) Int. Cl. A01K 47/06

(52) U.S. Cl. CPC A01K 47/06

(57) ABSTRACT

An inner cover of a beehive that has an R-value of 25-40 and a thickness that is generally equal to the thickness of conventional inner covers. The inner cover can be formed entirely or partially by a vacuum insulated panel (VIP). The VIP can also be included in an outer cover of the beehive. A beehive wrap-around insulation system is also described, where the wrap-around insulation system includes insulation panels with an R-value of at least 6.

### FIELD

The technology described herein relates to beehives, and to improving the thermal insulation of the beehives.

### BACKGROUND

Honey bees are used for a variety of purposes such as honey production, crop pollination, beeswax production, and the like. Beehives are used to maintain colonies of honey bees. The internal temperature of the beehive is important in maintaining the health of the colony, as well as maximizing honey and beeswax production by the colony. Honey bees have developed techniques that allow them to control internal temperature of the beehive. However, the more work the honey bees are required to do in order to control the temperature, the more energy the honey bees consume which stresses the honey bees and reduces honey and beeswax production. In addition, mechanical temperature regulation via construction of the beehive can be difficult.

### SUMMARY

Improvements in beehive construction are described that mechanically improve internal temperature regulation of the beehive. The improvements described herein can be used on any type or construction of beehives where internal temperature regulation is necessary.

In one embodiment described herein, an inner cover of the beehive is provided that has an R-value of 25-40 and a thickness that is generally equal to the thickness of conventional beehive inner covers. In one embodiment, the inner cover can be formed entirely or partially by a vacuum insulated panel (VIP). The VIP preferably forms the entire area of the inner cover. In another embodiment, the VIP can form less than the entire area of the inner cover depending upon how much insulation one determines is required. Preferably, the VIP inner cover has a thickness equal to or less than the thickness of a conventional beehive inner cover. For example, the VIP inner cover can have a nominal thickness of about 20 mm or less. In another embodiment, the VIP described herein can be used in an outer cover of the beehive.

In another embodiment, wrap around insulation panels are provided to wrap around the hive box of the beehive. The insulation panels can be made of insulating material, such as but not limited to polystyrene foam, with each panel having an R-value of at least 6. The panels are configured to connect to one another so as to be secured around and cover the side walls of the hive box.

In one embodiment, a beehive described herein comprises a hive box that is configured to house a colony of honey bees, and a VIP at a top of the hive box. The VIP can be part of an inner cover and/or part of an outer cover. The VIP can be used by itself as the sole insulation material or the VIP can be used together with other insulation material. In an embodiment, the VIP can have a thickness from about 0.5 inches to about 2.0 inches.

In another embodiment, a beehive described herein comprises a hive box that is configured to house a colony of honey bees, and an inner cover at a top of the hive box. The inner cover has a nominal thickness equal to about 20 mm or less and an R-value of 25-40.

The inner covers described herein, whether formed as a VIP or formed in another manner, can be sized and shaped to function as an inner cover for a single beehive or sized and shaped to function as a common inner cover for multiple beehives.

In still another embodiment, a beehive cover of a hive box of a beehive described herein is provided, where the beehive cover comprises a VIP.

In still another embodiment, a wrap-around insulation system is described that is configured to wrap around a hive box of a beehive. The wrap-around insulation system can include four or more separate panels of polystyrene foam each with an R-value of at least 6, with each panel being sized to completely cover a respective side wall of the hive box. In addition, each panel has opposite end edges that are configured to mechanically interlock with end edges of an adjacent pair of the panels.

The wrap-around insulation system described herein can be sized and shaped to wrap around a single beehive, or sized and shaped to wrap around multiple beehives that are arranged side-by-side or otherwise arranged.

### DRAWINGS

FIG. 1 is an exploded view of a conventional beehive.

FIG. 2 is a front perspective view of a beehive with an inner cover described herein.

FIGS. 3 and 4 are further front perspective views of a beehive described herein together with an insulation wrap system around the hive box.

FIG. 5 is a front view of a portion of a front insulation panel with a removable bee door formed in the panel.

FIG. 6 is a front view showing the bee door of FIG. 5 open.

FIGS. 7A and 7B are an end view and a top view, respectively, of the inner cover described herein.

FIGS. 8A, 8B and 8C illustrate a front, rear, and side insulation panels, respectively, described herein.

### DETAILED DESCRIPTION

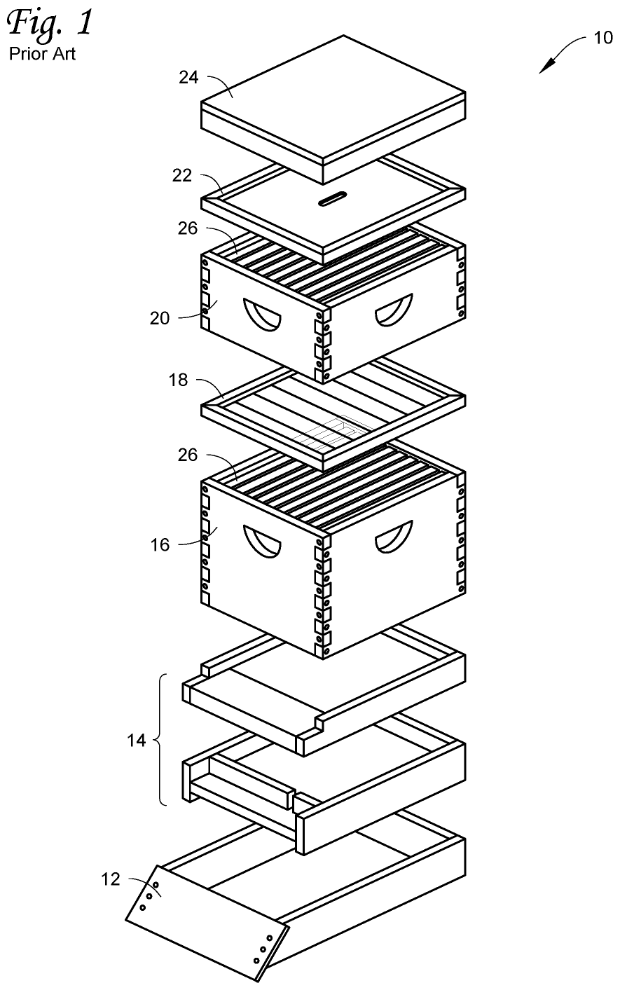

FIG. 1 illustrates an example of a conventional beehive 10. In this example construction, the beehive 10 includes a hive stand 12, a bottom board 14, a hive body 16, a queen excluder 18, a super 20, an inner cover 22, and a telescoping outer cover 24. A number of removable frames 26 are removably mounted in the hive body 16 and in the super 20. These elements of the beehive 10 are all well known to those of ordinary skill in the art and detailed description of their construction and purpose are not provided herein.

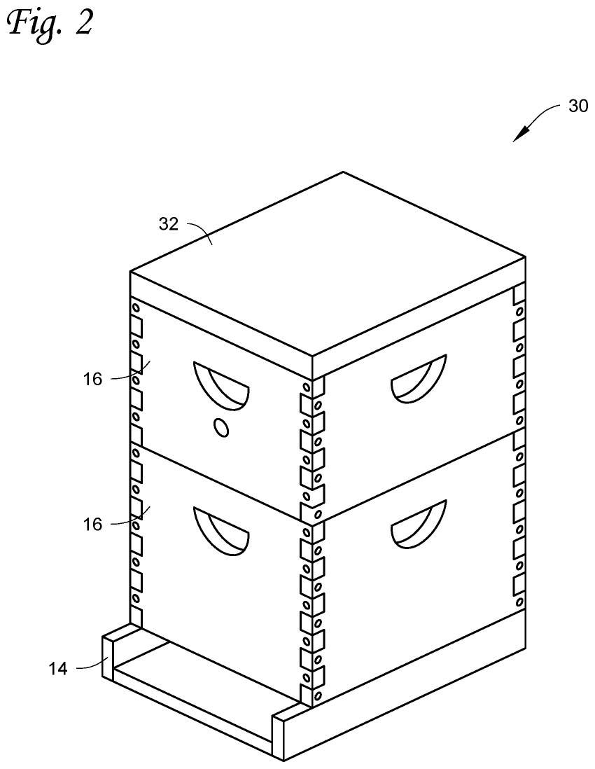

Referring to FIG. 2, a beehive 30 having an improved construction as described herein is depicted. In FIG. 2, elements of the beehive 30 that are similar to elements in the beehive 10 of FIG. 1 are referenced using the same reference numerals. The beehive 30 is depicted in FIG. 2 as including the bottom board 14, and two of the hive bodies 16 stacked on top of one another. The beehive 30 can also include a queen excluder (not shown), a telescoping outer cover (not shown), and removable frames (not shown) similar to the corresponding elements illustrated in FIG. 1. The beehive 30 may also optionally include one or more supers and a hive stand.

Alternatively to the construction depicted in FIG. 2, the beehive 30 may have any number of the hive bodies 16 and/or the supers 20 (depicted in FIG. 1) used together in any combinations thereof. For example, there can be two of the hive bodies 16 together with one or more of the supers 20, one of the hive bodies 16 with one or more of the supers 20, and other combinations. The hive bodies 16, hive body(ies) 16 and super(s) 20, etc. may together be referred to as a hive box. The configuration illustrated in FIG. 2 using two of the hive bodies 16 that are stacked on one another is one configuration that would be suitable for overwintering honey bees. However, a single hive body 16 can also be used.

The beehive 30 in FIG. 2 includes a beehive inner cover 32 that differs from the beehive inner cover 22 of the beehive 10 in FIG. 1. The general purpose and function of the beehive inner cover 32 is the same as the beehive inner cover 22 in FIG. 1. However, the beehive inner cover 32 has a construction that differs from the construction of the conventional beehive inner cover 22.

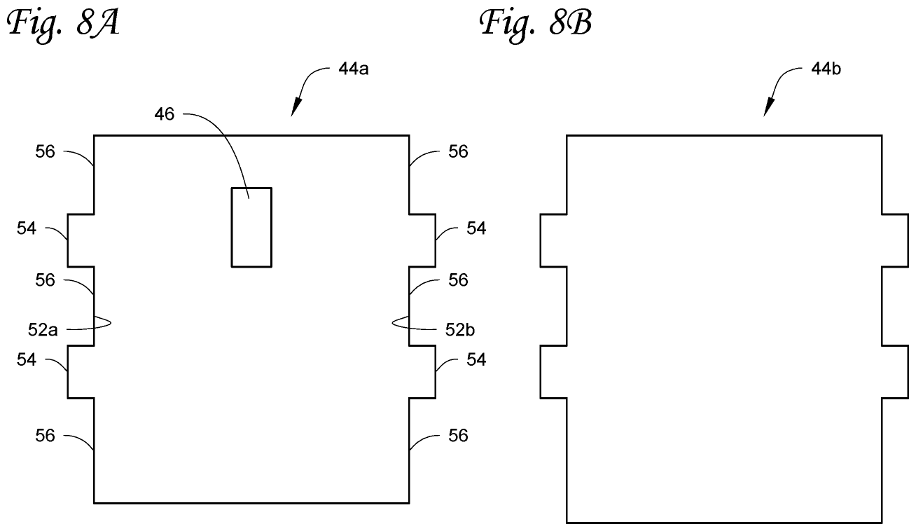

For example, referring to FIGS. 2, 7A and 7B, the beehive inner cover 32 is highly insulative with an R-value that is orders of magnitude greater than the R-value of the conventional beehive inner cover 22, while having a thickness T that is equal to, or substantially equal to, or less than the thickness of the conventional beehive inner cover 22 which is typically about 20 mm. In one embodiment, the inner cover 32 has an R-value of 25-40. In another embodiment, the R-value of the inner cover 32 can be 25-35 or 25-30. In another embodiment, the R-value of the inner cover 32 can be 25. In contrast, the conventional inner cover 22 is made of wood and has an R-value of about 1.05. In addition, in one embodiment, the inner cover 32 can have a thickness T of from about 19 mm to about 21 mm (about 0.75 inch to about 0.83 inch), or a nominal thickness of about 20 mm (0.79 inch). However, the inner cover 32 can have other thickness values.

With continued reference to FIGS. 2, 7A and 7B, the inner cover 32 can also have a perimeter shape that is the same as, or substantially the same as, the perimeter shape of the conventional inner cover 22. For example, the inner cover 32 can be rectangular. In one embodiment, the inner cover 32 can have a width W of about 416 mm to about 421 mm (about 16.38 inches to about 16.57 inches), and a length L of about 502 mm to about 507 mm (about 19.76 inches to about 19.96 inches). In another embodiment, the inner cover 32 can have a nominal width W of about 419 mm (or about 16.5 inches) and a nominal length L of about 505 mm (or about 19.88 inches). However, the inner cover 32 can be other widths W and lengths L as well.

As used herein, the term “nominal” as in “nominal thickness”, “nominal width” and “nominal length” refers to a target or design dimension. The actual thickness, width or length may deviate from the nominal thickness, nominal width and nominal length due to standard manufacturing tolerances and the like.

The inner cover 32 can be formed from any insulative material that provides the high R-values described above, preferably while also providing the inner cover 32 with a thickness that is substantially equal to or less than the thickness of the conventional inner cover 22. For example, in one embodiment, the inner cover 32 can be formed from a vacuum insulated panel (VIP). The VIP can form the entire area of the inner cover 32 (in other words, the entire inner cover 32 is formed by the VIP), or the VIP can form only portion of the area of the inner cover 32 (for example, 50%, 60%, 70%, 80%, 90%, etc. of the inner cover 32 as long as the high R-value can be achieved). In another embodiment, the VIP can be incorporated into the outer cover separately from the inner cover 32, or in addition to a VIP in the inner cover 32. In an embodiment, the VIP can have a thickness from about 0.5 inches to about 2.0 inches. In an embodiment, the VIP can be used by itself or used together with another insulation material. As depicted in FIG. 7B, the inner cover 32 is depicted as being solid and without any openings extending therethrough. In another embodiment, the inner cover 32 can have an opening therethrough like in the conventional inner cover 22 of FIG. 1.

In addition, the inner cover 32 can be sized and shaped to act as an insulating cover for more than one beehive. For example, two or more beehives may be arranged side-by-side, end-to-end, or combinations thereof in a column and row arrangement. The inner cover 32, including when formed as a VIP or formed of other high insulating material with the high R-values described herein, can be sized and shaped to cover the hive boxes of the two or more beehives.

Referring back to FIG. 2, a sealing gasket 34 can be provided between the inner cover 32 and an upper surface of the upper hive body 16 (or other upper element of the hive box such as a super if the super forms the upper element of the hive box) that forms a seal between the inner cover 32 and the hive box. The sealing gasket 34 can be formed of an elastomeric material, for example rubber, and the sealing gasket 34 can be fixed to the inner cover 32 or to the hive body 16.

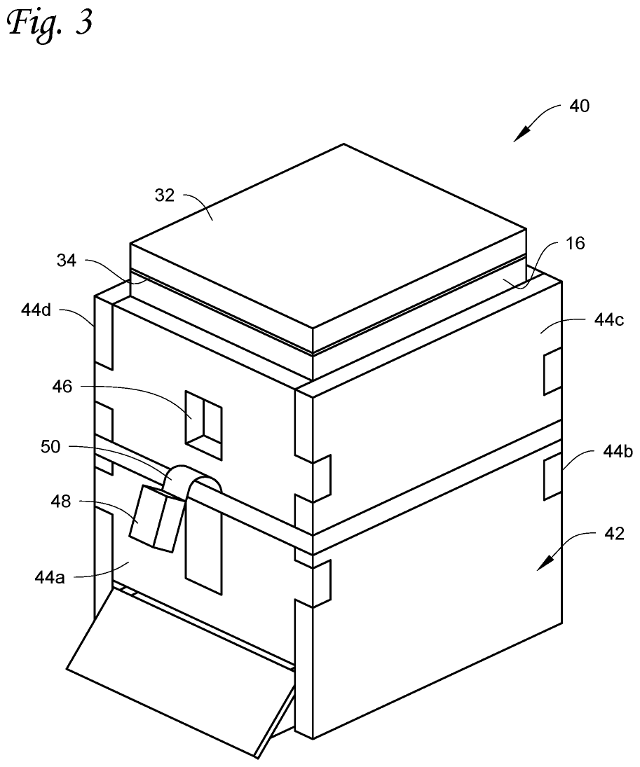

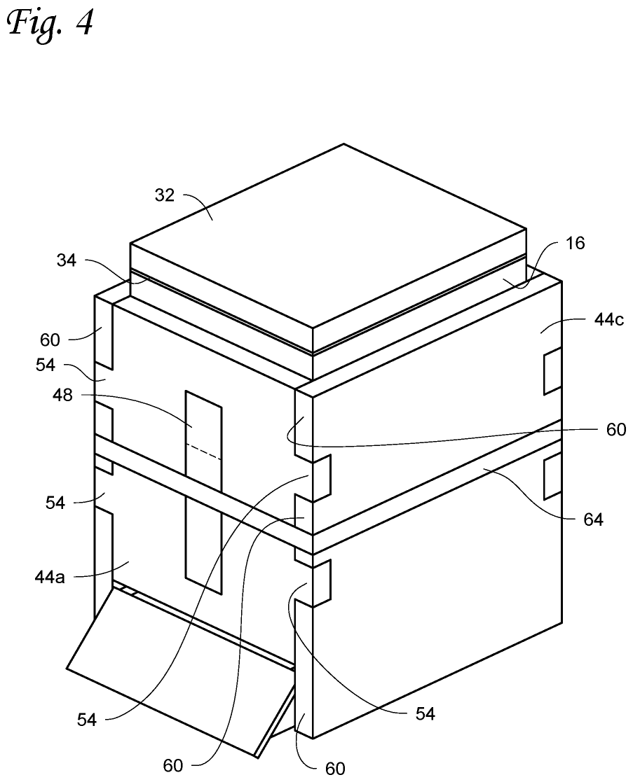

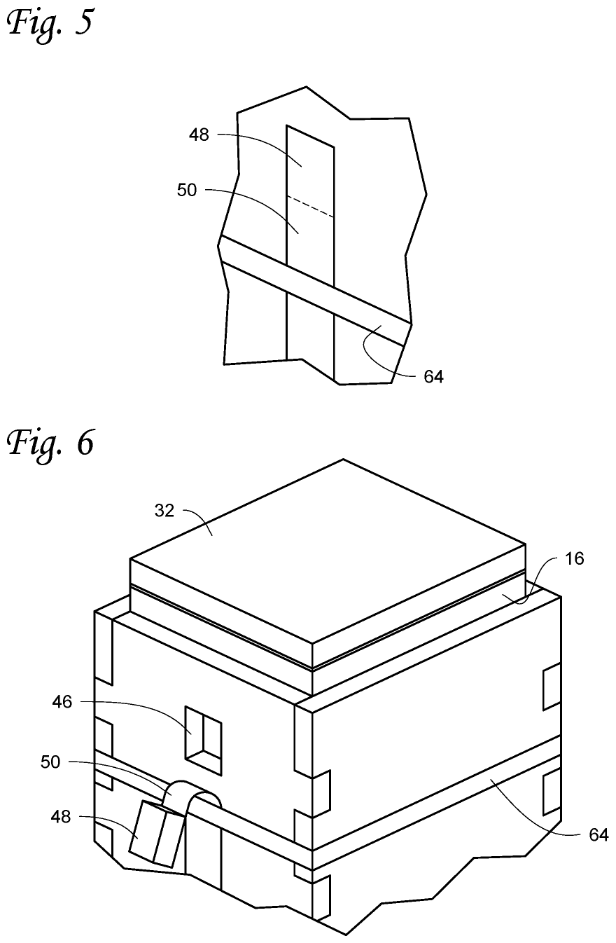

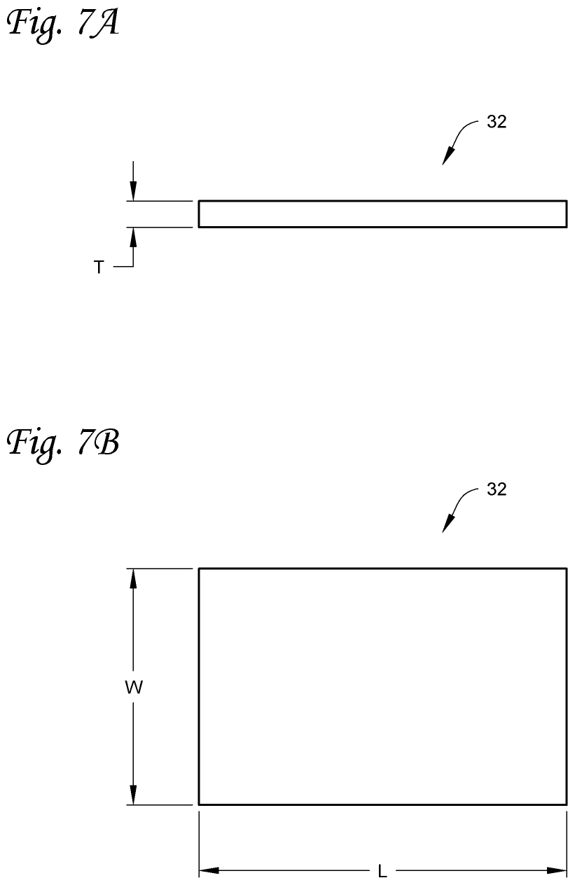

Referring now to FIGS. 3-6, another example of a beehive 40 having an improved construction as described herein is depicted. In FIGS. 3-6, elements of the beehive 40 that are similar to elements in the beehive 30 of FIG. 2 and similar to elements in the beehive 10 of FIG. 1 are referenced using the same reference numerals. The beehive 40 can have a construction similar to the beehive 30 including a similar hive box and the inner cover 32 with sealing gasket 34.

The beehive 40 in FIGS. 3-6 differs from the beehive 30 in that the beehive 40 includes a wrap-around insulation system 42 that is configured to wrap around the hive box. The insulation system 42 insulates the sides of the beehive 40. The insulation system 42 can also be used on a beehive that does not use the inner cover 32.

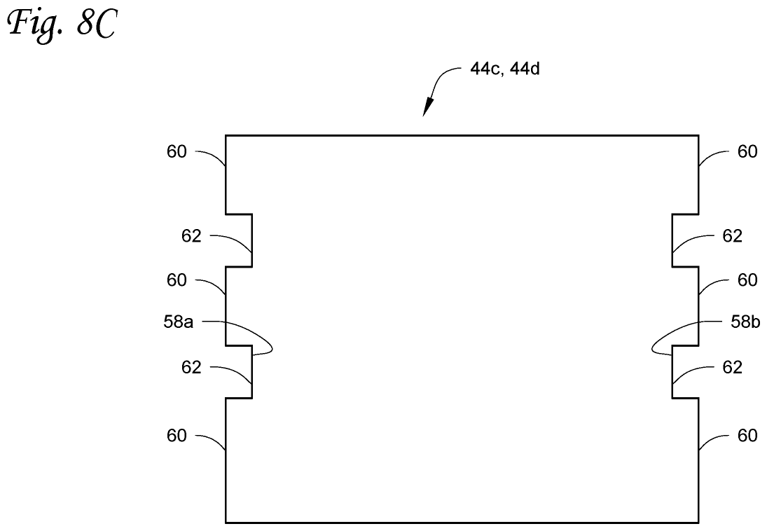

With continued reference to FIGS. 306, the wrap around insulation system 42 comprises at least four separate panels 44a, 44b, 44c, 44d of polystyrene foam, with each panel 44a-d having an R-value of at least 6. The panels 44a-d can be formed from insulation material other than polystyrene foam as long as a generally equivalent R-value is provided. The R-value of the panels 44a-d is less than 40 but at least 6. Each panel 44a-d is sized to completely cover a respective side wall of the hive box. For example, the panel 44a is configured to completely cover the front of the hive box, the panel 44b (best seen in FIG. 8B) is configured to completely cover the rear of the hive box, the panel 44c is configured to completely cover the right side (when viewing FIG. 3) of the hive box, and the panel 44d is configured to completely cover the left side (when viewing FIG. 3) of the hive box. A larger number of panels can be used if the panels, once connected together, cover the entire hive box.

Referring to FIGS. 8A-8C, the panels 44a, 44b have a generally similar overall shape and construction. However, the panel 44a can have an opening 46 formed therein that is aligned with an opening formed in the hive box when the panel 44a is mounted in position. The panel 44b is solid without any openings formed therethrough. The panels 44c, 44d have substantially identical shapes and construction. Each panel 44a-d can have a nominal thickness of about 38 mm (about 1.5 inches) although other thicknesses can be used.

Referring to FIGS. 3-6, a bee door 48 is provided that removably fits within the opening 46 to close the opening 46 when the opening 46 is not required. The bee door 48 can be formed by the insulation material that is cut from the panel 44a to form the opening 46, or the bee door 48 can be formed by a different structure. The beer door 48 can be secured to the panel 44a by a tether 50. In one embodiment, the tether 50 can be formed by a strip of foil material that encases the panel 44a. Alternatively, the tether 50 can be formed by a strip of hook and loop material that is secured to the bee door 48 and to the panel 44a.

Referring to FIGS. 3-8 and 8A-C, each panel 44a-d has opposite end edges that are configured to mechanically interlock with end edges of an adjacent pair of the panels without using any external or additional mechanical fasteners such as nails, screws, bolts and the like. The end edges can have any configuration that permits mechanical interlocking of the end edges of the panels. For example, referring to FIG. 8A, the panel 44a has opposite end edges 52a, 52b, each end edge 52a, 52b having a castellated construction or a construction with a plurality of male protrusions 54 separated by female indentations 56. The panel 44b has end edges having a similar construction as depicted in FIG. 8B. Similarly, referring to FIG. 8C, the panels 44c, 44d have end edges 58a, 58b, with each end edge 58a, 58b having a castellated construction or a construction with a plurality of male protrusions 60 separated by female indentations 62.

As best seen in FIGS. 3-6, the male protrusions 54 on the panels 44a, 44b are sized, shaped and positioned to engage in the female indentations 62 of the panels 44c, 44d. Likewise, the male protrusions 60 on the panels 44c, 44d are sized, shaped and positioned to engage in the female indentations 56 of the panels 44a, 44b. The male protrusions and female indentations can friction fit together. Optionally, a strap 64 can extend around the panels 44a-d to help secure the panels to one another and help retain the panels on the beehive 40. The strap 64 can be a hook and loop strap, a strap with a buckle, tape, string, wire, or any other structure that can extend around the panels 44a-d.

FIGS. 3-6 depict the wrap-around insulation system 42 being configured to wrap around the hive box of a single beehive. However, the wrap-around insulation system 42 can be configured to wrap around two or more hive boxes of two or more beehives. For example, two or more beehives may be arranged side-by-side, end-to-end, or combinations thereof such as in a column and row arrangement. The panels of the wrap-around insulation system 42 can be sized and shaped to wrap around the hive boxes of the two or more beehives. In such an arrangement, more than four panels can be used.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A beehive comprising a hive box that is configured to house a colony of honey bees, and a vacuum insulated panel at a top of the hive box.

2. The beehive of claim 1, wherein the vacuum insulated panel is part of an inner cover of the hive box, and the vacuum insulated panel forms the entire area of the inner cover.

3. The beehive of claim 1, wherein the vacuum insulated panel has a nominal thickness equal to or less than about 20 mm.

4. The beehive of claim 3, wherein the vacuum insulated panel has a nominal width of about 419 mm and a nominal length of about 505 mm.

5. The beehive of claim 1, further comprising a sealing gasket along a perimeter of the vacuum insulated panel that seals between the vacuum insulated panel and the hive box.

6. The beehive of claim 1, further comprising insulation installed around the hive box, the insulation comprises polystyrene foam with an R-value of at least 6.

7. The beehive of claim 1, wherein the vacuum insulated panel has an R-value of 25-40.

8. A beehive comprising a hive box that is configured to house a colony of honey bees, and an inner cover at a top of the hive box, the inner cover has a nominal thickness equal to or less than about 20 mm and an R-value of 25-40.

9. The beehive of claim 8, wherein the inner cover has a nominal width of about 419 mm and a nominal length of about 505 mm.

10. The beehive of claim 8, further comprising a sealing gasket along a perimeter of the inner cover that seals between the inner cover and the hive box.

11. The beehive of claim 8, further comprising insulation installed around the hive box, the insulation comprises polystyrene foam with an R-value of at least 6.

12. A beehive cover for a hive box of a beehive, the beehive cover comprises a vacuum insulated panel.

13. The beehive cover of claim 12, wherein the beehive cover is a beehive inner cover, and the vacuum insulated panel forms the entire area of the beehive inner cover.

14. The beehive cover of claim 12, wherein the vacuum insulated panel has a nominal thickness equal to or less than about 20 mm.

15. The beehive cover of claim 14, wherein the vacuum insulated panel has a nominal width of about 419 mm and a nominal length of about 505 mm.

16. The beehive cover of claim 12, wherein the vacuum insulated panel has an R-value of 25-40.

17. A beehive wrap-around insulation system configured to wrap around a hive box of a beehive, the beehive wrap-around insulation system comprising at least four separate panels of polystyrene foam each with an R-value of at least 6, each panel is sized to completely cover a respective side wall of the hive box, and each panel has opposite end edges that are configured to mechanically interlock with end edges of an adjacent pair of the panels.

18. The beehive wrap-around insulation system of claim 17, wherein each panel has a nominal thickness of about 38 mm.
